(19) United States
(12) Patent Application Publication
(10) Pub. No.: US 2025/0363432 A1
(43) Pub. Date: Nov. 27, 2025

(54) UNIFIED RESOURCE CAPACITY MANAGEMENT

(71) Applicant: o9 Solutions, Inc., Dallas, TX (US)

(72) Inventors: Sudarshan Gopinath, Bangalore (IN); Mayuri Deb, Bangalore (IN); Shrinivas Asanare, Irving, TX (US)

(21) Appl. No.: 18/671,274

(22) Filed: May 22, 2024

(51) Int. Cl. G06Q 10/0631; G06Q 10/1091

(52) U.S. Cl. CPC G06Q 10/06315; G06Q 10/1091

(57) ABSTRACT

Systems and techniques for unified resource capacity data management are described herein. An aggregate shift duration, a number of shifts, and an aggregate downtime duration within a specific calendar period may be determined, using a machine learning model, for each resource of a plurality of resources. A scheduling available capacity may be generated for the plurality of resources using the determined aggregate shift duration, the number of shifts, and the aggregate downtime duration. A planning available capacity may be generated using the scheduling available capacity and a retrieved efficiency factor. An optimal resource allocation may be calculated based on the planning available capacity and a customer demand. An indication that the set of training data was updated based on the optimal resource allocation may be received. The planning available capacity for each resource of the plurality of resources may be updated based on the updated set of training data.

### TECHNICAL FIELD

Embodiments described herein generally relate to data structure of common resource capacity and its availability data model for scheduling and planning.

### BACKGROUND

Scheduling and Planning solutions talk to each other at a regular cadence. The resource scheduling data model horizon is typically represented as the frozen horizon in Planning. The resource data modeling in Planning is kept at a higher granularity level for simplicity and performance reasons. Whereas Scheduling resource modeling is done at its lowest granularity.

### BRIEF SUMMARY

Accurate management of resource available capacity across resource scheduling data model and resource planning data model is a challenging task due to differences in granularity and flattening of routing. A lot of noise and delay in the process is due to the granularity difference that exists between scheduling and planning data models.

This process provides solutions to keep scheduling and planning calendars accurately and automatically in sync. Capacity information will be imported or managed at the lowest granularity and synced with planning using one of the solutions.

With this proposed process improvement, the resource model is combined for both data models, resulting in a seamless and accurate update of available capacity across solutions. The detailed description below shows the steps to combine the data models and calculate the available capacity.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example of a system for a unified resource capacity data management via routing flattening.

FIG. 2 is a diagram of an example of a system for a unified resource capacity data management via resource grouping.

FIG. 3 is a diagram of an example of a system for a unified resource capacity data management via resource and routing flattening.

FIG. 4A is a table illustrating an example of a set of training data for a unified resource capacity data management.

FIG. 4B is a table illustrating the calculated scheduling available capacity and efficiency factor for a unified resource capacity data management, according to various examples.

FIG. 4C is a table illustrating the calculated planning available capacity for a unified resource capacity data management, according to various examples.

FIG. 5 is a flowchart illustrating a method for unified resource capacity data management in accordance with various examples.

FIG. 6 illustrates an example machine learning component for configuration option recommendation selection for a unified resource capacity data management, according to an embodiment.

FIG. 7 is a block diagram illustrating an example of a machine, within which a set or sequence of instructions may be executed to cause the machine to perform any one or more of the techniques discussed herein, according to various examples.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

The present inventors have recognized, among other things, that a problem to be solved can include inconsistent results for the same horizon between the resource scheduling data model and the resource planning data model. Resource scheduling data model and resource planning data model are related but different models in resource capacity management systems.

The resource planning data model encompasses determining the optimal resource allocation to match products offered with customer demand. The resource planning data model includes a comprehensive analysis of the operational aspects of a production line to ascertain which resources should be used, how long those resources should be used, and the like. Resource planning ensures an optimal resource allocation for meeting customer demands.

The resource scheduling data model involves a deeper analysis of the operational aspects of the production line to determine more specific details of when (e.g., precise date and time, precise order, or the like) and how exactly each resource will be used. The resource scheduling data model and the resource planning data model may analyze the same line of production but at different levels of granularity.

The resource scheduling data model involves a more detailed, short-term management tool, whereas resource planning involves management decisions focused on the big picture of the production process for simplicity and performance reasons. In other words, resource scheduling has a lower granularity and higher fidelity than resource planning.

Accurate management of resource available capacity across resource scheduling data model and resource planning data model is a challenging task due to differences in granularity and flattening of routing. For example, resource management systems may not be seamless, with each interaction taking a long time and with a chance of data mismatch. This results in inconsistent models for the same time horizon.

The systems and techniques described herein can help provide a solution to this problem, such as by automatically and accurately keeping the resource scheduling data model and the resource planning data model in sync. In various examples, the systems and techniques described herein leverage machine learning (ML) and artificial intelligence (AI) to determine. In various examples, the resource capacity data will be imported or managed at the lowest granularity, that is, from the resource scheduling data model, and synced with the resource planning data model.

Furthermore, improvements in performance may be realized as the present systems and techniques allow for a unified resource capacity data management that combines the resource scheduling data model and the resource planning data model resulting in seamless and accurate update of available capacity across solutions. The techniques and systems discussed herein provide the resource scheduling data model with the ability to process a high volume of resources in an efficient manner by calculating and aggregating the scheduling available capacity of the resources and feeding the bucketized planning available capacity. The systems and techniques described herein may improve the ability to process big data/scaled datasets of large customers with complex optimal resource allocation. The section below details the steps to combine the models and calculate the available capacity.

Throughout this disclosure, components may take electronic actions in response to different variable values (e.g., thresholds, user preferences, or the like). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

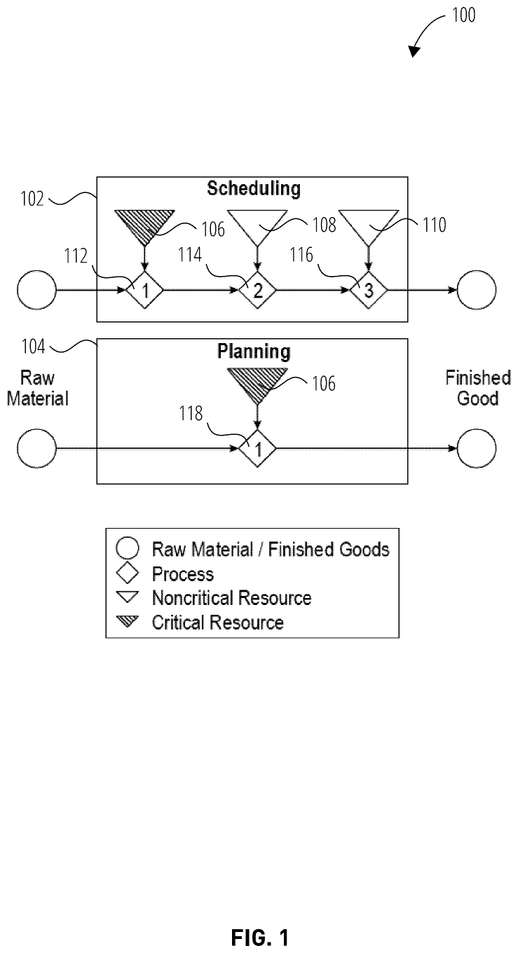

FIG. 1 is a diagram representing an example of a unified resource capacity data management via routing flattening including a scheduling data model 102 and a planning data model 104. In various examples, the scheduling data model 102 has a detailed multi-step routing operation including multiple processes (e.g., process 112, process 114, and process 116). The scheduling system 102 models scheduling available capacity based on all available resources at the production line, including critical resources (e.g., critical resource 106) and non-critical resources (e.g., non-critical resource 108 and non-critical resource 110). Whereas, as shown in the example of FIG. 1, the planning data model 104 models planning available capacity based only on critical resources (e.g., critical resource 106) or bottleneck resources. In the example shown in FIG. 1, the production line routing of the planning data model 104 is flattened, including only one step (process 118) instead of the three steps of scheduling data model 102.

Critical resources are the resources that set the pace of a production line and have the greatest impact, in case of a failure, on the production line. For example, a shop floor may have three machines, for example, a lathe, a grinding machine, and a buffing machine. A product may go through all three machines for processing, and the time consumed on the lathe machine may always be higher than the time to go through the grinding machine and the buffing machine. In this example, the lathe machine is a critical resource. A bottleneck resource is a critical resource that must be fully functional to avoid a bottleneck in the production line. On the other hand, the failure of a non-critical resource has a low impact or does not affect the production line.

In an example, in a horizon of a week, the scheduling available capacity and planning available capacity will be calculated as shown in Table 1 below.

TABLE 1
Formulas for calculating scheduling available capacity and
planning available capacity in an example of a unified
resource capacity data management via routing flattening.

| Scheduling available capacity | Planning available capacity |
|---|---|
| Scheduling available | Planning available capacity = Scheduling |
| capacity = (Shift Duration * | available capacity * Efficiency factor = |
| Number of Shifts per day * | (Available Hours in a Week − Weekly |
| 7) − Weekly Downtime | Downtime) * Efficiency factor |
| Example | Example |
| (8 * 3 * 7) − 30 = 138 hrs | (168 − 30) * 0.9 = 124 hours |
| Critical and Non-Critical | Only Critical Resources Capacity |
| Resources capacity is | with efficiency factored is modeled |
| modeled and available | and available |

The formulas are meant to represent how to aggregate the high-fidelity scheduling available capacity in terms of resource strength and chronological availability (e.g., shift and calendar patterns) to feed the bucketized planning available capacity. Hence, reducing the redundant effort of maintaining the scheduling available capacity and planning available capacity separately. Since the aggregate level resource planning is done in bucketized time units (e.g., days, weeks, or the like), the efficiency factor is necessary to adjust for non-value-added times like changeovers (e.g., changing a tool, jig, mold, or the like, cleaning the equipment, changing materials fed into the process, or the like), setup activities, unloading activities, preventive maintenance (e.g., lubrification, safety checks, or the like), unplanned downtime (e.g., breakdowns, non-availability of raw materials, tooling, labor, or the like), or the like. The available hours in a Week may be calculated as an aggregate based on the shift calendar pattern for a resource in the scheduling data model 102.

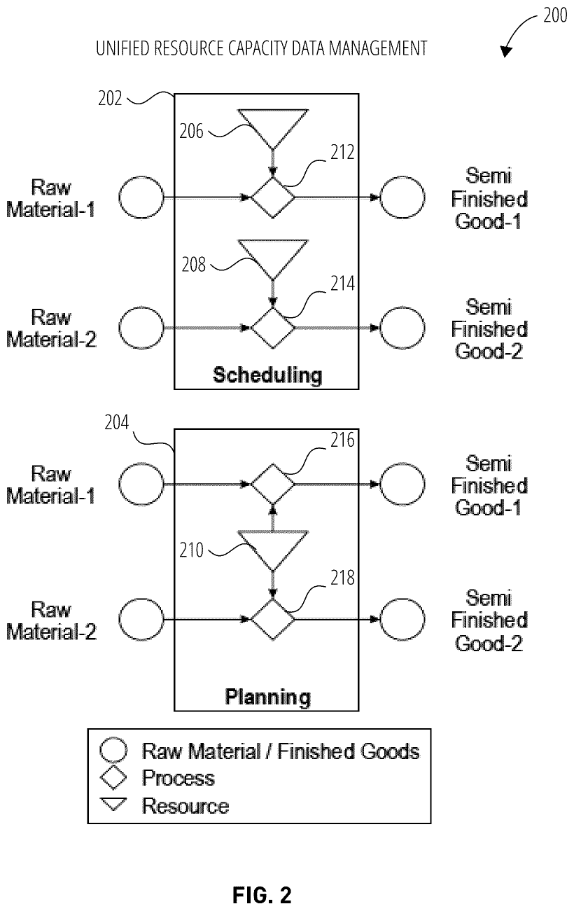

FIG. 2 is a diagram representing an example of a unified resource capacity data management system 200 via resource grouping. In various examples, the unified resource capacity data management system 200 via resource grouping does not differentiate critical resources from non-critical resources to calculate scheduling available capacity and planning available capacity. In the example shown in FIG. 2, scheduling has different resources (e.g., resource 206 and resource 208) producing different items in similar routing (e.g., process 212 and process 214). While in Planning, these resources are grouped into a single aggregate level resource (e.g., aggregate level resource 210).

In the example shown in FIG. 2, the calculation of the scheduling available capacity and planning available capacity is shown in Table 2 below.

TABLE 2
Formulas for calculating scheduling available capacity and planning available capacity
in an example of a unified resource capacity data management via resource grouping.

| Scheduling available capacity | Planning available capacity |
|---|---|
| $Scheduling available capacity = {\sum }_{i = 1}^{n}$ $( Available Capacity ( i ) - Downtime ( i ) )$ | $Planning available capacity = Scheduling$ $available capacity * Efficiency factor =$ $( {\sum }_{i = 1}^{n} ( Available Capacity ( i ) -$ $Downtime ( i ) ) ) * Efficiency factor$ |

The “n” in the formulas represents the number of resources that have been grouped to form the aggregate level resource.

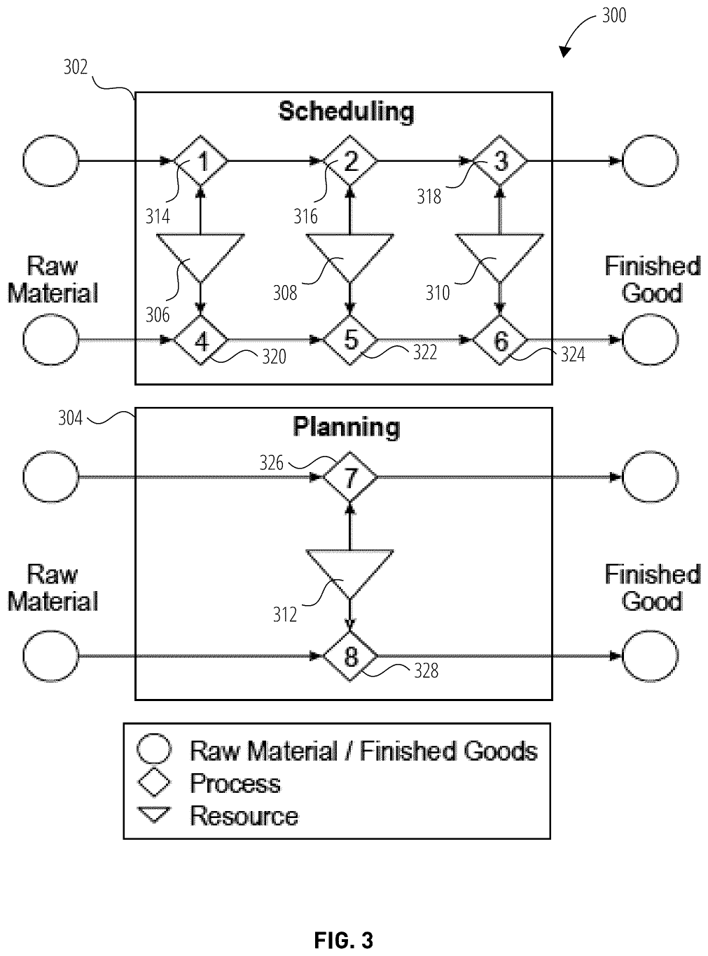

FIG. 3 is a diagram representing an example of a unified resource capacity data management system 300 via resource and routing flattening. In various examples, the unified resource capacity data management system 300 includes a resource scheduling data model 302 having multiple steps routing (e.g., process 314, process 316, process 318, process 320, process 322, and process 324) with parallel and sequential operations and a resource planning data model 304. The resource planning data model 304 has a pseudo resource 312. A pseudo resource is a notional resource modeled in the higher-level aggregated resource planning data model and does not represent a physical resource (as typically modeled in the resource scheduling data model).

In an example, the finished good may be a chair. In this example, the resource scheduling data model 302 may include three steps: attach back and base (e.g., process 314, process 320), assemble the legs (e.g., process 316, process 322) and paint the chair (e.g., process 318, process 324). In the resource planning data model 304 those three steps may be combined into one single step of building a chair (e.g., process 326, process 328) with combined throughput.

In the example shown in FIG. 3, the calculation of scheduling available capacity remains as the available operating hours, but the planning available capacity for the pseudo resource 312 is calculated as a throughput based on resource scheduling data model 302 output data or based on historical data, as shown in Table 3 below. Throughput refers to the total amount of time to run a process (e.g., process 326, process 328, or the like) from the start (e.g., raw material) to the end of the process (e.g., finished good).

TABLE 3
Formulas for calculating the planning available capacity
in an example of unified resource capacity data management
via resource and routing flattening.

| | Based on scheduling | |
|---|---|---|
| Planning | output data | Based on historical data |
| Available | Planning available capacity = | Planning available |
| Capacity | Weighted average of | capacity = Minimum |
| in Hours | throughput for all runs | throughput of all the |
| | unit/hours × Available Hours | individual resources |

In various examples, a labor team's scheduling available capacity may be calculated for the resource scheduling data model 302 where similarly skilled laborers are grouped together as a labor resource. In other examples, the planning available capacity may be calculated for the resource planning data model 304 based on available hours.

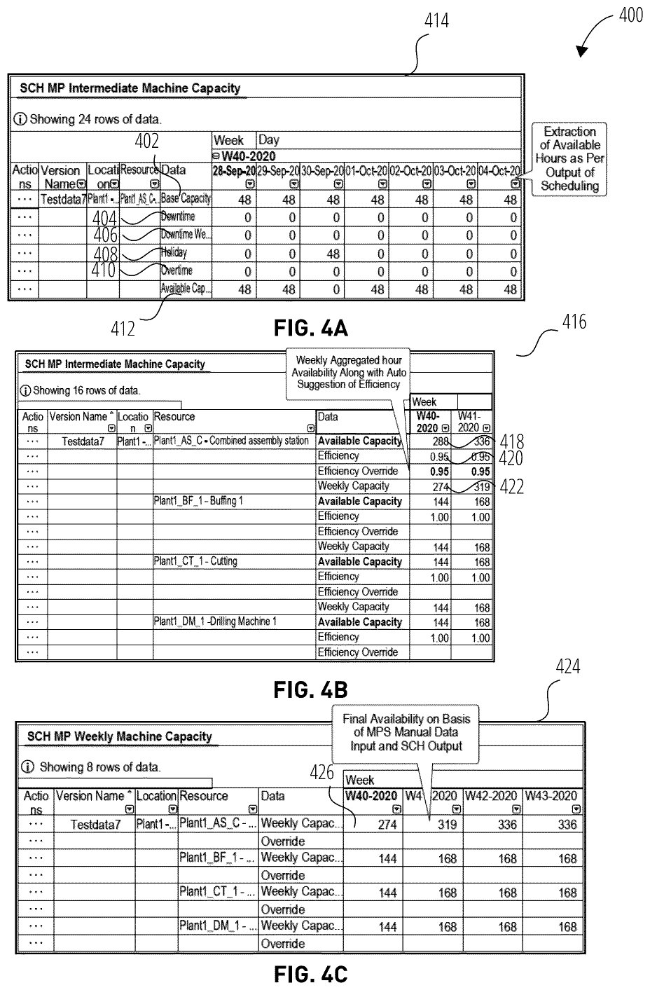

FIG. 4A shows data table 414 illustrating an example of a set of training data for a specific calendar period (week 40). The data table 414 includes data of a time availability 402, a downtime duration 404, an aggregate downtime duration 406, a holiday time off 408, overtime 410, and a scheduling available capacity 412. Each value of the scheduling available capacity 412 is shown for the specific calendar period of one day. The scheduling available capacity 412 is calculated as the time availability 402 minus aggregate downtime duration 406 minus holiday time off 408 plus overtime 410.

Machine learning (ML) models may inspect the relationships between various training data of the set of training data. For example, a set of training data including data for a plurality of resources may be used to train a machine learning model. In an example, a machine learning algorithm may be applied to the set of training data to determine at least one of an aggregate shift duration, a number of shifts, or an aggregate downtime duration for each resource of the plurality of resources within a specific calendar period. The plurality of resources may include one or more critical resources and one or more non-critical resources.

FIG. 4B shows data table 416 illustrating the scheduling available capacity 418 for a specific calendar period (e.g., week 40), the efficiency factor 420 for the specific calendar period of week 40 and the planning available capacity 422 for the specific calendar period of week 40. The scheduling available capacity for week 40 is calculated using the daily scheduling available capacity 412 data in data table 416 shown in FIG. 4A. The planning available capacity 422 for the specific calendar period of week 40 is calculated by multiplying the scheduling available capacity 418 by the efficiency factor 420. In the example shown in FIG. 4A, week 40 has 6 (six) days with 48 hours of scheduling available capacity 412 and 1 (one) day with 0 (zero) hours of scheduling available capacity 412 resulting in a total of 288 (two hundred and eighty-eight) hours of scheduling available capacity 418.

FIG. 4C shows data table 424 illustrating the planning available capacity 426 for several resources by week. The planning available capacity 426 was calculated as described above in FIG. 4B. In an example, a machine learning algorithm may calculate an optimal resource allocation based on the planning available capacity 426 and a customer demand. In the example shown in FIGS. 4A-C, week 40 has a planning available capacity for each resource equal to the scheduling available capacity of the resource versus the efficiency factor of the resource. For example, the planning available capacity 426 of the resource combined assembly station is equal to scheduling available capacity 418 versus efficiency factor 420, that is, 288 (two hundred and eighty-eight) versus 0.95 (ninety-five hundredths) which equals approximately 274 (two hundred and seventy-four).

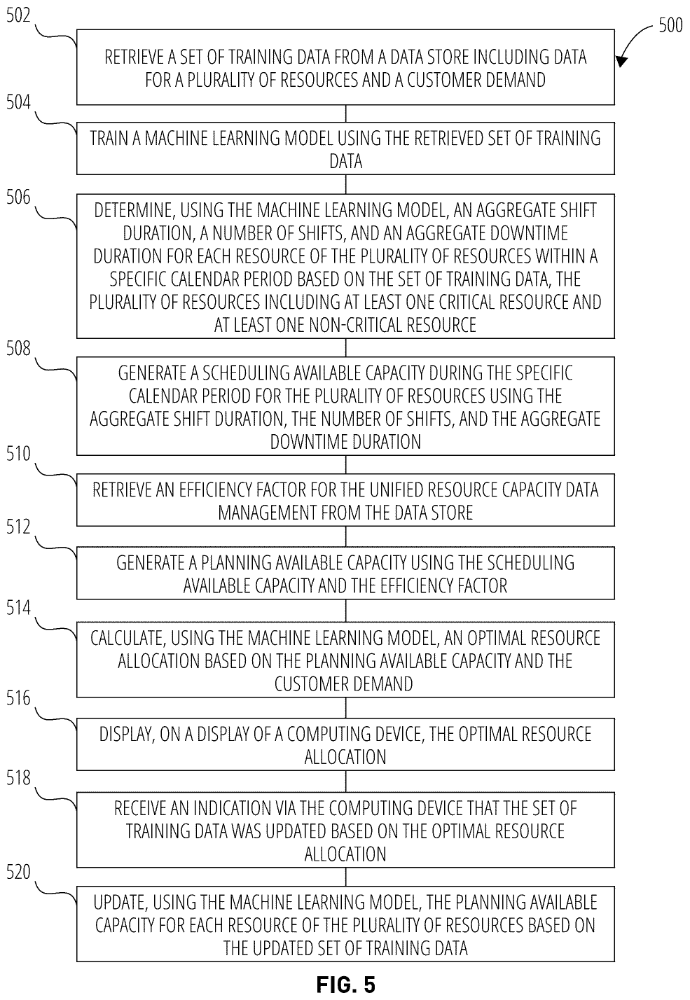

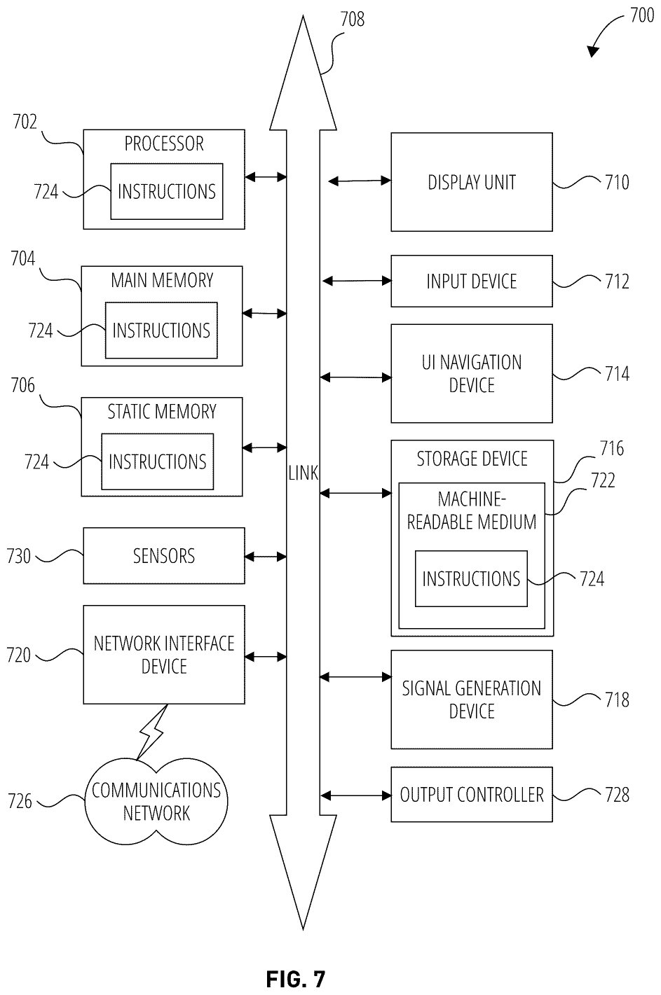

FIG. 5 is a flowchart illustrating technique 500 for unified resource capacity data management, according to various examples. The technique 500 may provide features as described in FIG. 1 through FIG. 4C. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 7.

The technique 500 includes an operation 502 to retrieve a set of training data from a data store, the set of training data including data for a plurality of resources and a customer demand.

The technique 500 includes an operation 504 to train a machine learning model using the retrieved set of training data.

The technique 500 includes an operation 506 to determine, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource. In various examples, the specific calendar period may be a day, a week, a month, a year, or the like.

The technique 500 includes an operation 508 to generate a scheduling available capacity during the specific calendar period for the plurality of resources using the aggregate shift duration, the number of shifts, and the aggregate downtime duration. In various examples, the aggregate shift duration and aggregate downtime duration are calculated in hours.

The technique 500 includes an operation 510 to retrieve an efficiency factor for the unified resource capacity data management from the data store. In various examples, the efficiency factor is based, in part, on an aggregate changeover time and an aggregate maintenance time during the specific calendar period.

The technique 500 includes an operation 512 to generate a planning available capacity using the scheduling available capacity and the efficiency factor. In various examples, the planning available capacity may be generated only for the at least one critical resource of the plurality of resources.

The technique 500 includes an operation 514 to calculate, using the machine learning model, an optimal resource allocation based on the planning available capacity and the customer demand. The technique 500 includes an operation 516 to display, on a display of a computing device, the optimal resource allocation.

The technique 500 includes an operation 518 to receive an indication via the computing device that the set of training data was updated based on the optimal resource allocation.

The technique 500 includes an operation 520 to update, using the machine learning model, the planning available capacity for each resource of the plurality of resources based on the updated set of training data.

In various examples, the technique 500 includes an operation to calculate, using the machine learning model, an aggregate scheduling available capacity for the plurality of resources and generate a second planning available capacity using the aggregate scheduling available capacity and the efficiency factor. In other examples, the technique 500 includes an operation to retrieve, from the data store, an inventory of units produced for the specific calendar period. In those examples, the technique 500 may include an operation to calculate, using the machine learning model, a throughput rate based on the inventory of units produced and a time availability. The time availability may be based on the aggregate shift duration, the number of shifts, and the specific calendar period. In some examples, the technique 500 includes an operation to generate a third planning available capacity using the throughput rate and the time availability for the plurality of resources.

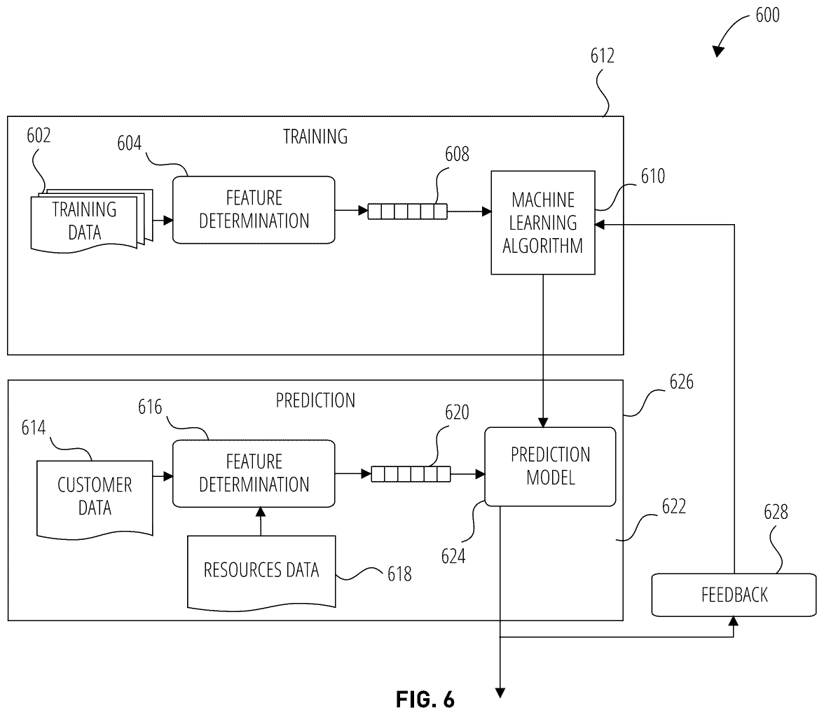

FIG. 6 illustrates an example machine learning component 600 for a unified resource capacity data management system, according to an embodiment. The machine learning component utilizes a training module 612 and a prediction module 626. Training module 612 feeds training data 602 into feature determination module 616 which determines one or more features 608 from this information. The training data 602 includes customer demand data and data for a plurality of resources. Features 608 are a subset of the information input and is information determined to be predictive of optimal resource allocations based on a client demand and an available capacity. Examples of features 608 include an aggregate shift duration, a number of shifts, an aggregate downtime duration, or the like. In various examples, the features 608 are determined for each resource of a plurality of resources within a specific calendar period.

The machine learning algorithm 610 produces a prediction model 624 based upon the features 608 and feedback 628 associated with those features. For example, the features associated with past resource allocations for past customer demands are used as a set of training data. As noted above, the prediction model 624 may be for the entire system (e.g., built of training data accumulated throughout the entire system, regardless of the resource for which an optimal allocation is being calculated), or may be built specific for each resource of a plurality of resources.

In the prediction module 626, the current customer data 614 (e.g., data describing the current customer demand, etc.) may be input to the feature determination module 616. Similarly applicable resources data 618 is also input to the feature determination module 616. Feature determination module 616 may determine the same set of features or a different set of features as feature determination module 604. In some examples, feature determination module 616 and feature determination module 604 are the same module. Feature determination module 616 produces features 620, which are input into the prediction model 624.

It should be noted that the prediction model 624 may be periodically updated via additional training and/or feedback 628. The feedback 628 may be feedback from users of the unified resource capacity data management system that provides explicit feedback (e.g., responses to questions about whether a resource allocation is fulfilling customer demands in an efficient manner, etc.) or may be automated feedback 628 based on outcomes of the optimal resource allocation.

The machine learning algorithm 610 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method. In an example embodiment, a multi-class logistical regression model is used.

FIG. 7 illustrates a block diagram of an example of a machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine 700 (e.g., computer system) may include a hardware processor 702 (e.g., a central processing unit (CPU), a graphics processing unit (GPU), a hardware processor core, or any combination thereof), a main memory 704 and a static memory 706, some or all of which may communicate with each other via a link 708 (e.g., bus). The machine 700 may further include a display unit 710, an input device 712 (e.g., a keyboard), and a UI navigation device 714 (e.g., a mouse). In an example, the display unit 710, input device 712, and UI navigation device 714 may be a touch screen display. The machine 700 may additionally include a storage device 716 (e.g., drive unit), a signal generation device 718 (e.g., a speaker), a network interface device 720, and one or more sensors 730, such as a global positioning system (GPS) sensor, compass, accelerometer, or other sensors. The machine 700 may include an output controller 728, such as a serial (e.g., universal serial bus (USB), parallel, or other wired or wireless (e.g., infrared (IR), near field communication (NFC), or the like) connection to communicate or control one or more peripheral devices (e.g., a printer, card reader, etc.).

The storage device 716 may include a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the processor 702 during execution thereof by the machine 700. In an example, one or any combination of the processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions 724.

The term “machine-readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine-readable media may exclude transitory propagating signals (e.g., non-transitory machine-readable storage media). Specific examples of non-transitory machine-readable storage media may include nonvolatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), or the like). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, or the like), IEEE 802.15.4 family of standards, peer-to-peer (P2P) networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

Example 1 is a system comprising: a storage device, comprising a data store to host data provided from a unified resource capacity data management; at least one processor; and memory including instructions that, when executed by the at least one processor, cause the at least one processor to perform operations to: retrieve a set of training data from the data store, the set of training data including data for a plurality of resources and a customer demand; train a machine learning model using the retrieved set of training data; determine, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource; generate, using the at least one processor, a scheduling available capacity during the specific calendar period for the plurality of resources using the aggregate shift duration, the number of shifts, and the aggregate downtime duration; retrieve an efficiency factor for the unified resource capacity data management from the data store; generate a planning available capacity using the scheduling available capacity and the efficiency factor; calculate, using the machine learning model, an optimal resource allocation based on the planning available capacity and the customer demand; display, on a display of a computing device, the optimal resource allocation; receive an indication via the computing device that the set of training data was updated based on the optimal resource allocation; and update, using the machine learning model, the planning available capacity for each resource of the plurality of resources based on the updated set of training data.

In Example 2, the subject matter of Example 1 includes, the memory further comprising instructions that, when executed by the at least one processor, cause the at least one processor to perform operations to: automatically identify a change in the set of training data for a resource of the plurality of resources; and update the planning available capacity for the resource of the plurality of resources.

In Example 3, the subject matter of Examples 1-2 includes, wherein the planning available capacity is generated only for the at least one critical resource of the plurality of resources.

In Example 4, the subject matter of Examples 1-3 includes, wherein the specific calendar period includes at least one of a day, a week, a month, or a year.

In Example 5, the subject matter of Examples 1-4 includes, wherein the aggregate shift duration and aggregate downtime duration are calculated in hours.

In Example 6, the subject matter of Examples 1-5 includes, wherein the efficiency factor is based in part on an aggregate changeover time and an aggregate maintenance time during the specific calendar period.

In Example 7, the subject matter of Examples 1-6 includes, the memory further comprising instructions that, when executed by the at least one processor, cause the at least one processor to perform operations to: calculate, using the machine learning model, an aggregate scheduling available capacity for the plurality of resources; and generate a second planning available capacity using the aggregate scheduling available capacity and the efficiency factor. In Example 8, the subject matter of Examples 1-7 includes, the memory further

comprising instructions that, when executed by the at least one processor, cause the at least one processor to perform operations to: retrieve, from the data store, an inventory of units produced for the specific calendar period; calculate, using the machine learning model, a throughput rate based on the inventory of units produced and a time availability, the time availability based on the aggregate shift duration, the number of shifts, and the specific calendar period; and generate a third planning available capacity using the throughput rate and the time availability for the plurality of resources.

Example 9 is at least one non-transitory machine-readable medium comprising instructions for a unified resource capacity data management, which when executed by processing circuitry, cause the processing circuitry to perform operations to: retrieve a set of training data from a data store, the set of training data including data for a plurality of resources and a customer demand; train a machine learning model using the retrieved set of training data; determine, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource; generate, using the processing circuitry, a scheduling available capacity during the specific calendar period for the plurality of resources using the aggregate shift duration, the number of shifts, and the aggregate downtime duration; retrieve an efficiency factor for the unified resource capacity data management from the data store; generate a planning available capacity using the scheduling available capacity and the efficiency factor; calculate, using the machine learning model, an optimal resource allocation based on the planning available capacity and the customer demand; display, on a display of a computing device, the optimal resource allocation; receive an indication via the computing device that the set of training data was updated based on the optimal resource allocation; and update, using the machine learning model, the planning available capacity for each resource of the plurality of resources based on the updated set of training data.

In Example 10, the subject matter of Example 9 includes, instructions that, when executed by the processing circuitry, cause the processing circuitry to perform operations to: automatically identify a change in the set of training data for a resource of the plurality of resources; and update the planning available capacity for the resource of the plurality of resources.

In Example 11, the subject matter of Examples 9-10 includes, wherein the planning available capacity is generated only for the at least one critical resource of the plurality of resources.

In Example 12, the subject matter of Examples 9-11 includes, wherein the specific calendar period includes at least one of a day, a week, a month, or a year.

In Example 13, the subject matter of Examples 9-12 includes, wherein the aggregate shift duration and aggregate downtime duration are calculated in hours.

In Example 14, the subject matter of Examples 9-13 includes, wherein the efficiency factor is based in part on an aggregate changeover time and an aggregate maintenance time during the specific calendar period.

In Example 15, the subject matter of Examples 9-14 includes, instructions that, when executed by the processing circuitry, cause the processing circuitry to perform operations to: calculate, using the machine learning model, an aggregate scheduling available capacity for the plurality of resources; and generate a second planning available capacity using the aggregate scheduling available capacity and the efficiency factor.

In Example 16, the subject matter of Examples 9-15 includes, instructions that, when executed by the processing circuitry, cause the processing circuitry to perform operations to: retrieve, from the data store, an inventory of units produced for the specific calendar period; calculate, using the machine learning model, a throughput rate based on the inventory of units produced and a time availability, the time availability based on the aggregate shift duration, the number of shifts, and the specific calendar period; and generate a third planning available capacity using the throughput rate and the time availability for the plurality of resources.

Example 17 is a method for a unified resource capacity data management, the method comprising: retrieving a set of training data from a data store, the set of training data including data for a plurality of resources and a customer demand; training a machine learning model using the retrieved set of training data; determining, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource; generating a scheduling available capacity during the specific calendar period for the plurality of resources using the aggregate shift duration, the number of shifts, and the aggregate downtime duration; retrieving an efficiency factor for the unified resource capacity data management from the data store; generating a planning available capacity using the scheduling available capacity and the efficiency factor; calculating, using the machine learning model, an optimal resource allocation based on the planning available capacity and the customer demand; displaying, on a display of a computing device, the optimal resource allocation; receiving an indication via the computing device that the set of training data was updated based on the optimal resource allocation; and updating, using the machine learning model, the planning available capacity for each resource of the plurality of resources based on the updated set of training data.

In Example 18, the subject matter of Example 17 includes, automatically identifying a change in the set of training data for a resource of the plurality of resources; and updating the planning available capacity for the resource of the plurality of resources.

In Example 19, the subject matter of Examples 17-18 includes, wherein the planning available capacity is generated only for the at least one critical resource of the plurality of resources.

In Example 20, the subject matter of Examples 17-19 includes, wherein the specific calendar period includes at least one of a day, a week, a month, or a year.

In Example 21, the subject matter of Examples 17-20 includes, wherein the aggregate shift duration and aggregate downtime duration are calculated in hours.

In Example 22, the subject matter of Examples 17-21 includes, wherein the efficiency factor is based in part on an aggregate changeover time and an aggregate maintenance time during the specific calendar period.

In Example 23, the subject matter of Examples 17-22 includes, calculating, using the machine learning model, an aggregate scheduling available capacity for the plurality of resources; and generating a second planning available capacity using the aggregate scheduling available capacity and the efficiency factor.

In Example 24, the subject matter of Examples 17-23 includes, retrieving, from the data store, an inventory of units produced for the specific calendar period; calculating, using the machine learning model, a throughput rate based on the inventory of units produced and a time availability, the time availability based on the aggregate shift duration, the number of shifts, and the specific calendar period; and generating a third planning available capacity using the throughput rate and the time availability for the plurality of resources.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24

Example 27 is a system to implement of any of Examples 1-24.

Example 28 is a method to implement of any of Examples 1-24.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system comprising:
a storage device, comprising a data store to host data provided from a unified resource capacity data management;
at least one processor; and
memory including instructions that, when executed by the at least one processor, cause the at least one processor to perform operations to:
receive a set of training data from the data store, the set of training data including data for a plurality of resources and a customer demand;
train a machine learning model using the received set of training data;
determine, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource;
generate, using the at least one processor, a scheduling available capacity during the specific calendar period for the plurality of resources using the aggregate shift duration, the number of shifts, and the aggregate downtime duration;
receive an efficiency factor for the unified resource capacity data management from the data store;
generate a planning available capacity using the scheduling available capacity and the efficiency factor;
calculate, using the machine learning model, an optimal resource allocation based on the planning available capacity and the customer demand;
display, on a display of a computing device, the optimal resource allocation;
receive an indication via the computing device that the set of training data was updated based on the optimal resource allocation; and
update, using the machine learning model, the planning available capacity for each resource of the plurality of resources based on the updated set of training data.

2. The system of claim 1, the memory further comprising instructions that, when executed by the at least one processor, cause the at least one processor to perform operations to:
automatically identify a change in the set of training data for a resource of the plurality of resources; and
update the planning available capacity for the resource of the plurality of resources.

3. The system of claim 1, wherein the planning available capacity is generated only for the at least one critical resource of the plurality of resources.

4. The system of claim 1, wherein the specific calendar period includes at least one of a day, a week, a month, or a year.

5. The system of claim 1, wherein the aggregate shift duration and aggregate downtime duration are calculated in hours.

6. The system of claim 1, wherein the efficiency factor is based in part on an aggregate changeover time and an aggregate maintenance time during the specific calendar period.

7. The system of claim 1, the memory further comprising instructions that, when executed by the at least one processor, cause the at least one processor to perform operations to:
calculate, using the machine learning model, an aggregate scheduling available capacity for the plurality of resources; and
generate a second planning available capacity using the aggregate scheduling available capacity and the efficiency factor.

8. The system of claim 1, the memory further comprising instructions that, when executed by the at least one processor, cause the at least one processor to perform operations to:
retrieve, from the data store, an inventory of units produced for the specific calendar period;
calculate, using the machine learning model, a throughput rate based on the inventory of units produced and a time availability, the time availability based on the aggregate shift duration, the number of shifts, and the specific calendar period; and
generate a third planning available capacity using the throughput rate and the time availability for the plurality of resources.

9. At least one non-transitory machine-readable medium comprising instructions for a unified resource capacity data management, which when executed by processing circuitry, cause the processing circuitry to perform operations to:
retrieve a set of training data from a data store, the set of training data including data for a plurality of resources and a customer demand;
train a machine learning model using the retrieved set of training data;
determine, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource;
generate, using the processing circuitry, a scheduling available capacity during the specific calendar period for the plurality of resources using the aggregate shift duration, the number of shifts, and the aggregate downtime duration;
retrieve an efficiency factor for the unified resource capacity data management from the data store;
generate a planning available capacity using the scheduling available capacity and the efficiency factor;
calculate, using the machine learning model, an optimal resource allocation based on the planning available capacity and the customer demand;
display, on a display of a computing device, the optimal resource allocation;
receive an indication via the computing device that the set of training data was updated based on the optimal resource allocation; and
update, using the machine learning model, the planning available capacity for each resource of the plurality of resources based on the updated set of training data.

10. The at least one non-transitory machine-readable medium of claim 9, further comprising instructions that, when executed by the processing circuitry, cause the processing circuitry to perform operations to:
automatically identify a change in the set of training data for a resource of the plurality of resources; and
update the planning available capacity for the resource of the plurality of resources.

11. The at least one non-transitory machine-readable medium of claim 9, wherein the planning available capacity is generated only for the at least one critical resource of the plurality of resources.

12. The at least one non-transitory machine-readable medium of claim 9, wherein the specific calendar period includes at least one of a day, a week, a month, or a year.

13. The at least one non-transitory machine-readable medium of claim 9, wherein the aggregate shift duration and aggregate downtime duration are calculated in hours.

14. The at least one non-transitory machine-readable medium of claim 9, wherein the efficiency factor is based in part on an aggregate changeover time and an aggregate maintenance time during the specific calendar period.

15. The at least one non-transitory machine-readable medium of claim 9, further comprising instructions that, when executed by the processing circuitry, cause the processing circuitry to perform operations to:
calculate, using the machine learning model, an aggregate scheduling available capacity for the plurality of resources; and
generate a second planning available capacity using the aggregate scheduling available capacity and the efficiency factor.

16. The at least one non-transitory machine-readable medium of claim 9, further comprising instructions that, when executed by the processing circuitry, cause the processing circuitry to perform operations to:
retrieve, from the data store, an inventory of units produced for the specific calendar period;
calculate, using the machine learning model, a throughput rate based on the inventory of units produced and a time availability, the time availability based on the aggregate shift duration, the number of shifts, and the specific calendar period; and
generate a third planning available capacity using the throughput rate and the time availability for the plurality of resources.

17. A method for a unified resource capacity data management, the method comprising:
retrieving a set of training data from a data store, the set of training data including data for a plurality of resources and a customer demand;
training a machine learning model using the retrieved set of training data;
determining, using the machine learning model, an aggregate shift duration, a number of shifts, and an aggregate downtime duration for each resource of the plurality of resources within a specific calendar period based on the set of training data, the plurality of resources including at least one critical resource and at least one non-critical resource;
generating a scheduling available capacity during the specific calendar period for the plurality of resources using the aggregate shift duration, the number of shifts, and the aggregate downtime duration;
retrieving an efficiency factor for the unified resource capacity data management from the data store;
generating a planning available capacity using the scheduling available capacity and the efficiency factor;
calculating, using the machine learning model, an optimal resource allocation based on the planning available capacity and the customer demand;
displaying, on a display of a computing device, the optimal resource allocation;
receiving an indication via the computing device that the set of training data was updated based on the optimal resource allocation; and
updating, using the machine learning model, the planning available capacity for each resource of the plurality of resources based on the updated set of training data.

18. The method of claim 17, further comprising:
automatically identifying a change in the set of training data for a resource of the plurality of resources; and
updating the planning available capacity for the resource of the plurality of resources.

19. The method of claim 17, wherein the planning available capacity is generated only for the at least one critical resource of the plurality of resources.

20. The method of claim 17, wherein the specific calendar period includes at least one of a day, a week, a month, or a year.

21. The method of claim 17, wherein the aggregate shift duration and aggregate downtime duration are calculated in hours.

22. The method of claim 17, wherein the efficiency factor is based in part on an aggregate changeover time and an aggregate maintenance time during the specific calendar period.

23. The method of claim 17, further comprising:
calculating, using the machine learning model, an aggregate scheduling available capacity for the plurality of resources; and
generating a second planning available capacity using the aggregate scheduling available capacity and the efficiency factor.

24. The method of claim 17, further comprising:
retrieving, from the data store, an inventory of units produced for the specific calendar period;
calculating, using the machine learning model, a throughput rate based on the inventory of units produced and a time availability, the time availability based on the aggregate shift duration, the number of shifts, and the specific calendar period; and
generating a third planning available capacity using the throughput rate and the time availability for the plurality of resources.
